(19) United States
(12) Patent Application Publication
(10) Pub. No.: US 2011/0145201 A1
(43) Pub. Date: Jun. 16, 2011

(54) DATABASE MIRRORING

(75) Inventors: Marcel van der Holst, Issaquah, WA (US); Robin D. Dhamankar, Bellevue, WA (US); Hanumantha R. Kodavalla, Sammamish, WA (US); Srikumar Rangarajan, Sammamish, WA (US)

(73) Assignee: Microsoft Corporation, Redmond, WA (US)

(21) Appl. No.: 12/635,763

(22) Filed: Dec. 11, 2009

(51) Int. Cl. G06F 17/00; G06F 12/00

(52) U.S. Cl. 707/655; 707/E17.005; 711/E12.001

(57) ABSTRACT

Methods, systems, and computer-readable media of database mirroring are disclosed. A particular method includes initiating a transaction that modifies one or more pages of a first database. Each page includes a structure modification operation (SMO) bit and initiating the transaction includes setting the SMO bit of each of the one or more pages to a first value. One or more first records are created at a transaction log of the first database. The transaction log is useable at a second database to mirror the transaction. Each first record indicates the setting of a SMO bit of a particular page to the first value. The database transaction is performed, and the SMO bit of each of the one or more pages is set to a second value. One or more second records are created at the transaction log, each second record indicating the setting of a SMO bit of a particular page to the second value. The method includes committing the transaction.

### BACKGROUND

Data redundancy is often introduced into enterprise systems as a method of backup (e.g., to prevent data loss in the case of system failure). One method of data redundancy in the field of databases is database mirroring. In database mirroring, a secondary database is kept in a manner that mirrors a primary database. As modifications occur at the primary database, the modifications are mirrored at the secondary database. Thus, the secondary database is said to be a “mirror” of the primary database.

Secondary databases that are generated by mirroring are typically kept for backup purposes only. That is, even though the secondary database is kept identical to the primary database, the secondary database is usually not made available to clients, even in a read-only mode. This is usually done to avoid data integrity issues that may arise when data is read from the secondary database while a transaction that has already occurred at the primary database is being mirrored at the secondary database. For example, making a secondary database available to readers may result in potential deadlocks. To illustrate, a top-down database reader may attempt to acquire database synchronization objects in a top-down order and a bottom-up database writer may attempt to acquire database synchronization objects in a bottom-up order. A deadlock may result when the reader is waiting for a downstream synchronization object from the writer, and the writer is waiting an upstream synchronization object from the reader. To avoid deadlock situations in multi-page operations, locks for pages to be modified are acquired before modifying any of the pages, and the locks are released after all modifications have been performed. However, this may be inefficient, because individual pages undergoing minor modification may remain locked even after their modification is complete.

### SUMMARY

Systems and methods of database mirroring are disclosed, where reader threads and writer threads at a mirror database are synchronized such that the mirror database is available for read operations. In addition, a redo thread at a mirror database may latch (e.g., prohibit readers from reading) one database page at a time, even while mirroring large database transactions that modified multiple pages at a principal database. Thus, one or more readers may perform partial reads at a mirror database while a multi-page modification is being performed at the mirror database.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

FIG. 1 is a diagram to illustrate a particular embodiment of a system of database mirroring;

FIG. 2 is a diagram to illustrate a particular embodiment of a database transaction at the principal database of FIG. 1;

FIG. 3 is a diagram to illustrate a particular embodiment of a transaction log generated at the principal database of FIG. 1 based on the database transaction of FIG. 2;

FIG. 4 is a diagram to illustrate operation of the redo thread at the mirror database of FIG. 1 based on the transaction log of FIG. 3;

FIG. 5 is a flow diagram to illustrate a particular embodiment of a method of operation at a principal database involved in database mirroring;

FIG. 6 is a flow diagram to illustrate a particular embodiment of a method of redo thread operation at a mirror database involved in database mirroring;

FIG. 7 is a flow diagram to illustrate a particular embodiment of a method of reader thread operation at a mirror database involved in database mirroring; and

FIG. 8 is a block diagram of a computing environment including a computing device operable to support embodiments of computer-implemented methods, computer program products, and system components as illustrated in FIGS. 1-7.

### DETAILED DESCRIPTION

Systems, methods, and computer-readable media of database mirroring are disclosed. Database mirroring as disclosed herein may enable a mirror database to be available for read operations and may synchronize reader threads of the mirror database with a redo thread of the mirror database to preserve data integrity. Such database mirroring may be achieved using a three-part system. A first part of the system may involve transaction log generation at a principal database. A second part may involve a redo thread at a mirror database using the transaction log to reproduce (i.e., “mirror”) transactions of the principal database. A third part may involve operating reader threads at the mirror database. Each of the three parts may use structure modification operation (SMO) bits, SMO locks, and latches for synchronization purposes.

In a particular embodiment, a method includes initiating a database transaction at a first database. The first database includes a plurality of pages, and each of the plurality of pages includes a structure modification operation (SMO) bit. The database transaction modifies one or more pages of the first database and is initiated by setting the SMO bit of each of the one or more pages to a first value. The method also includes creating one or more first records in a transaction log of the first database. The transaction log is usable at a second database to mirror the database transaction. Each of the one or more first records indicates that the SMO bit of a particular page was set to the first value. The method further includes performing the database transaction, including modifying the one or more pages. The method includes setting the SMO bit of each of the one or more pages to a second value. The method also includes creating one or more second records in the transaction log. Each of the one or more second records indicates that the SMO bit of a particular page was set to the second value. The method further includes committing the database transaction.

In another particular embodiment, a method of mirroring a database transaction of a first database at a second database based on a transaction log of the first database is disclosed. The method includes determining that one or more first records of the transaction log indicate that a SMO bit of each of one or more pages of the first database is set to a first value. The method also includes identifying one or more pages of the second database that correspond to the one or more pages of the first database. The method further includes acquiring one or more exclusive SMO locks. Each particular exclusive SMO lock is associated with a particular page of one or more pages of the second database. The method includes setting a SMO bit of each of the one or more pages of the second database to the first value and mirroring the database transaction. Mirroring the database transaction includes modifying each of the one or more pages of the second database based on the transaction log. The method also includes determining that one or more second records of the transaction log indicate that the SMO bit of each of the one or more pages of the first database is set to a second value. The method further includes setting the SMO bit of the one or more pages of the second database to the second value. The method includes releasing the plurality of exclusive SMO locks after the mirroring is completed.

In another particular embodiment, a computer-readable medium is disclosed. The computer-readable medium includes instructions, that when executed by a computer, cause the computer to receive a command to initiate a read operation of a first page and a second page of a database. The command is received at a reader thread of the database. The instructions also cause the computer to acquire a first shared latch associated with the first page and to read first data from the first page of the database. The instructions further cause the computer to determine that a SMO bit of the second page indicates a pending database transaction at the second page. The instructions cause the computer to release the first shared latch and the second shared latch and to enter a sleep mode until a shared SMO lock associated with the second page is acquired. The shared SMO lock is acquired subsequent to completion of the pending database transaction. The instructions also cause the computer to re-acquire the second shared latch after acquiring the shared SMO lock and to determine that the SMO bit of the second page no longer indicates the pending database transaction at the second page. The instructions cause the computer to read second data from the second page of the database.

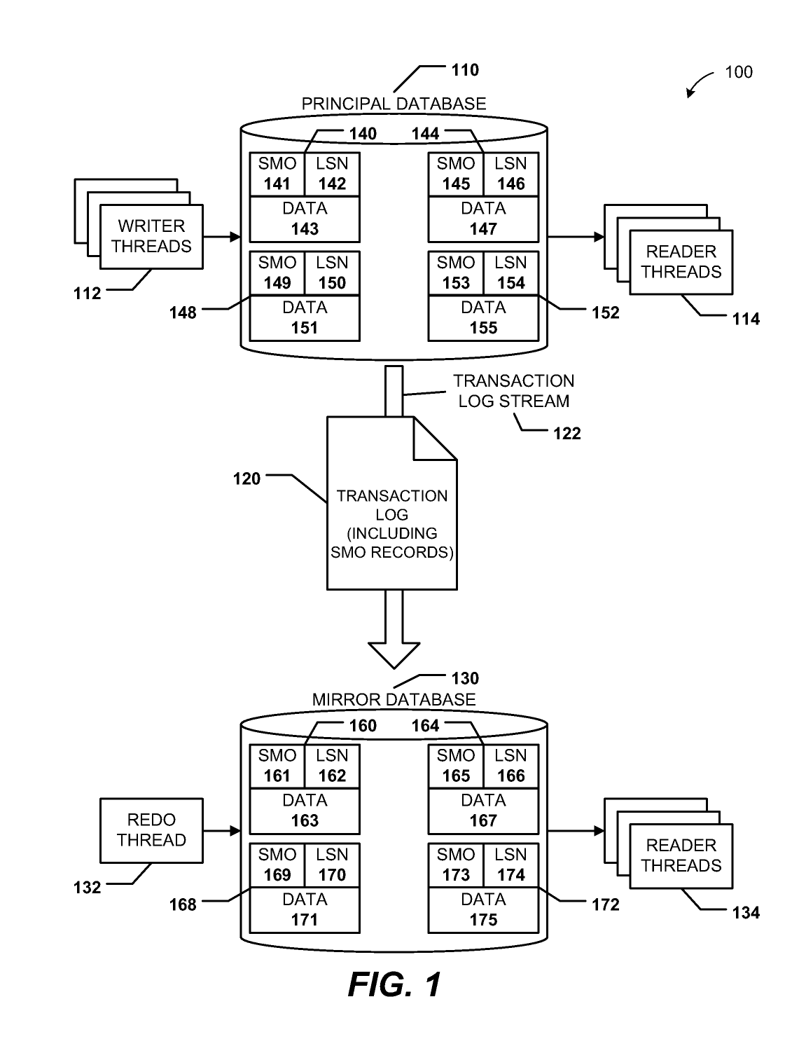

FIG. 1 is a diagram to illustrate a particular embodiment of a system 100 of database mirroring. In the particular embodiment illustrated in FIG. 1, a principal database 110 is mirrored at a mirror database 130 based on a transaction log 120 of the principal database 110.

The principal database 110 may be a read-write database that includes a plurality of pages 140, 144, 148, 152 that are accessible to a plurality of reader threads 114 and to a plurality of writer threads 112. Each of the plurality of reader threads 114 may read data 143, 147, 151, 155 from the pages 140, 144, 148, 152, respectively. Each of the plurality of writer threads 112 may write data 143, 147, 151, 155 to the pages 140, 144, 148, 152, respectively. In a particular embodiment, the reader threads 114 and writer threads 112 are synchronized to preserve data integrity (e.g., prevent a reader thread from reading data at a page that is being modified by a writer thread). For example, the reader threads 114 and the writer threads 112 may use shared mode and exclusive mode latches for synchronization.

In a particular embodiment, each page 140, 144, 148, 152 of the principal database 110 has an associated latch that may be acquired in either a shared mode or an exclusive mode. A latch may be acquired multiple times in shared mode but only once in exclusive mode. Thus, latches may support a “many-read, single-write” synchronization scheme. For example, multiple reader threads may acquire the latch for a particular page in the shared mode prior to reading data from the particular page. A writer thread may acquire the latch for the particular page in the exclusive mode prior to modifying a particular page, thereby preventing other reader threads from reading dirty (e.g., inconsistent) data and preventing other writer threads from overwriting the modifications before they are committed at the principal database 110.

The mirror database 130 may be located remotely from the principal database 110. The mirror database 130 is accessible by a redo thread 132 and one or more reader threads 134. The mirror database 130 may include a plurality of pages, including a corresponding page for each page of the principal database 110. For example, the pages 160, 164, 168, and 172 may correspond to the pages 140, 144, 148, and 152, respectively. Thus, database mirroring between the principal database 110 and the mirror database 130 may result in the data 163, 167, 171, and 175 being physically identical to the data 143, 147, 151, and 155, respectively.

As database transactions occur at the principal database 110, modifications to the principal database 110 are logged in the transaction log 120. The transaction log may be used by the redo thread 132 at the mirror database 130 to replicate (i.e., “mirror”) the database transactions of the principal database 110, thereby keeping the mirror database 130 physically identical to the principal database 110. In a particular embodiment, newly-generated records of the transaction log 120 are transmitted from the principal database 110 to the mirror database 130 via a transaction log stream 122. In another particular embodiment, transaction logs are transmitted from the principal database 110 to the mirror database 130 periodically.

In a particular embodiment, each record of the transaction log 120 has a log sequence number (LSN). For example, LSNs may increase when the transaction log 120 is arranged in chronological order. When the transaction log 120 includes LSNs, each page of the databases 110, 130 may include an LSN in the page header, where the value of the LSN at a particular page corresponds to the most recent record of the transaction log 120 associated with a modification of the particular page. For example, the pages 140, 144, 148, 152, 160, 164, 168, and 172 include the LSNs 142, 146, 150, 154, 162, 166, 170, and 174, respectively. Storing an LSN at each page of the databases 110, 130 may provide a timestamp at each page that indicates when each page was last modified.

Each page of the principal database 110 and the mirror database 130 includes a structure modification operation (SMO) bit. The SMO bit may be part of a page header of each page. For example, the pages 140, 144, 148, 152, 160, 164, 168, and 172 include the SMO bits 141, 141, 149, 153, 161, 165, 169, and 173, respectively. Both the principal database 110 and the mirror database 130 may support SMO locks. SMO bits and SMO locks may be used to mirror database transactions of the principal database 110 at the mirror database 130, as described herein. SMO bits and SMO locks may also be used to maintain synchronization between the redo thread 132 and the reader threads 134 of the mirror database 130, as described herein.

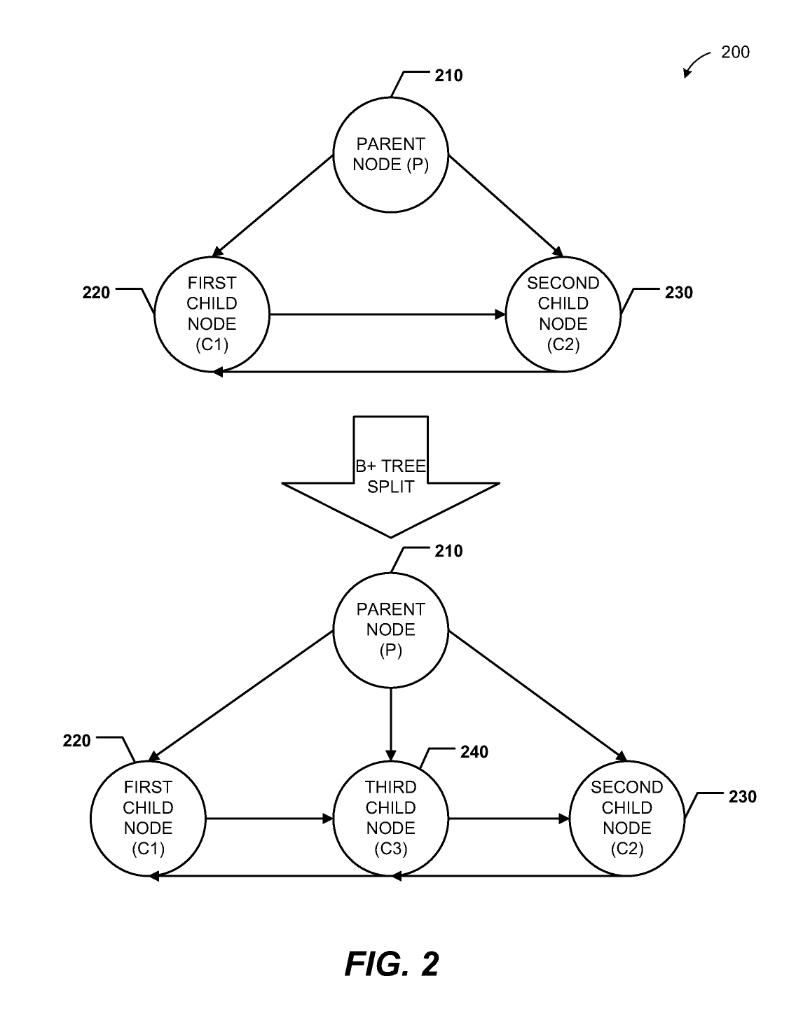

A particular embodiment of operation at the system 100 of FIG. 1 may be illustrated with reference to FIGS. 2-4.

FIG. 2 illustrates a particular embodiment of a database transaction 200 at the principal database 110 of FIG. 1. In the particular embodiment illustrated in FIG. 2, the database transaction is a B+ tree node splitting operation that results in a structural modification of the B+ tree. It should be noted that although FIG. 2 depicts a B+ tree node splitting operation, database mirroring as disclosed herein may be used with any database transaction. For example, the database transaction may alternately include a deletion operation, a defragmentation operation, or some other operation. It should also be noted that the database transaction may modify any number of pages.

Prior to the node splitting operation, the B+ tree includes a parent node P 210 that is connected to a first child node C1 220 and to a second child node C2 230. The parent node P 210 includes pointers to each of the child nodes C1-C2 220-230. Each of the child nodes C1-C2 220-230 includes pointers to each other, such as “previous leaf node” and “next leaf node” pointers. It should be noted that although the example depicted in FIG. 2 illustrates a leaf node split, the node splitting operation may occur at a higher (e.g., internal non-leaf node) level of the B+ tree. In such a scenario, the node to be split may include one or more child node pointers.

During the node splitting operation, some of the data stored at the first child node C1 220 may be moved to a newly allocated third child node C3 240. An additional pointer to the third child node C3 240 may be added to the parent node P 210, and the “previous leaf node” and “next leaf node” pointers of the child nodes C1-C3 220-240 may be modified as illustrated in FIG. 2.

In an illustrative embodiment, each node 210-240 corresponds to a particular page of the principal database 110 of FIG. 1. For example, the nodes 210, 220, 230, and 240 of the B+ tree may correspond to pages 140, 144, 148, and 152 of the principal database 110 of FIG. 1, respectively. Thus, each node 210-230 may have a SMO bit and a LSN. Each node 210-240 may also correspond to a particular page of the mirror database 130 of FIG. 1, because the mirror database 130 is kept identical (e.g., physically identical) to the principal database 110. For example, the nodes 210, 220, 230, and 240 of the B+ tree may also correspond to pages 160, 164, 168, and 172 of the mirror database 130 of FIG. 1, respectively.

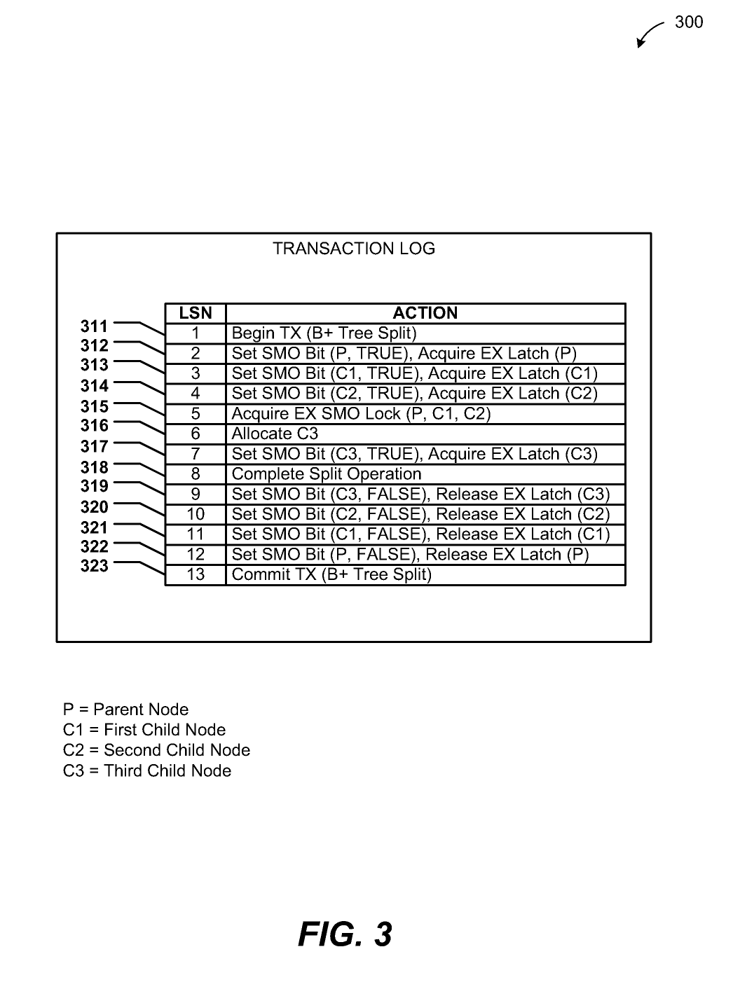

FIG. 3 is a diagram to illustrate a particular embodiment of a transaction log 300 based on the database transaction 200 of FIG. 2. In a particular embodiment, each record of the transaction log 300 includes a log sequence number (LSN). For example, in the particular embodiment illustrated in FIG. 3, records 311-323 are assigned LSNs 1-13, respectively.

In a particular embodiment, transaction log records are generated at a principal database to reflect operations performed in accordance with the following pseudocode:
1) Begin a database transaction.
2) For each page that will be modified during the database transaction, perform the following steps before changing the pages:
   a. Set the SMO bit of the page to a first value (e.g., binary 1 or TRUE).
   b. Acquire an exclusive SMO lock for the page.
3) Modify the pages in a pre-determined order (e.g., top-down left-to-right order at a B+ tree).
4) After all modifications are complete, set the SMO bit of the pages to a second value (e.g., binary 0 or FALSE) in opposite order (e.g., right-to-left bottom-up order at a B+ tree).
5) Commit the database transaction (and release each exclusive SMO lock acquired in step 2b).

In a particular embodiment, step 2) of the pseudocode further includes acquiring an exclusive latch for each page that is to be modified, and step 5) of the pseudocode further includes releasing the exclusive latches after the transaction is completed.

Thus, in accordance with the above pseudocode, the first record 311 may be added to the transaction log 300 to indicate the beginning of the “B+ Tree Split” transaction (TX) depicted in FIG. 2. An exclusive latch associated with each page (e.g., each node of the B+ tree depicted in FIG. 2) modified by the node splitting operation may be acquired, and the SMO bit of each page may be set to a first value (e.g., binary 1 or TRUE). The records 312-314 may be added to the transaction log 300 to indicate that an exclusive (EX) latch is acquired for each of the pages corresponding to the nodes 210-230 of FIG. 2, and that the SMO bit of the pages are set to the first value after the EX latches have been acquired. Acquiring exclusive latches for the pages may prevent reader threads (e.g., the reader threads 114) from reading data from the pages corresponding to the nodes 210-230 of FIG. 2 while the B+ tree split is pending.

In a particular embodiment, SMO bits are set to TRUE and exclusive latches are acquired in a particular order of the B+ tree. For example, the transaction log 300 of FIG. 3 indicates that SMO bits are set in a top-down left-to-right order.

An exclusive SMO lock associated with the pages modified by the node splitting operation may be acquired. The record 315 may be added to the transaction log 300 to indicate that an exclusive (EX) SMO lock is acquired for the pages. In a particular embodiment, a different exclusive SMO lock is acquired for each of the pages. In another particular embodiment, a single exclusive SMO lock on all of the pages may be acquired instead.

The record 316 may be added to the transaction log 300 to reflect the allocation of a new page corresponding to the third child node C3 240 of FIG. 2. A SMO bit of the new page may be set to the first value (e.g., binary 1 or TRUE) and an exclusive latch associated with the new page may be acquired, as illustrated by the record 317.

The record 318 of the transaction log 300 may reflect actions that are executed to complete the node splitting operation. For example, the record 318 may include instructions (e.g., to be followed by a redo thread at a mirror database) regarding how to add a pointer to the parent node 210 of FIG. 2 and modify “previous leaf node” and “next leaf node” pointers of the child nodes C1-C3 220-240 of FIG. 2. In a particular embodiment, completing the B+ tree split generates multiple records at the transaction log 300 instead of the single record 318. In an illustrative embodiment, the B+ tree split is performed by a writer thread, such as one of the writer threads 112 of FIG. 1 at the principal database 110 of FIG. 1.

Upon completion of the B+ tree node splitting operation, the SMO bits of the pages corresponding to the nodes 210-240 of FIG. 2 may be set to a second value (e.g., binary 0 or FALSE) and the exclusive latches associated with the pages may be released. The records 319-322 may be added to the transaction log 300 to reflect these actions. In a particular embodiment, SMO bits are set to FALSE and latches are released in reverse order of how they were set to TRUE. For example, whereas the records 312-314 and 317 indicate that SMO bits were set to TRUE in the order P, C1, C2, C3, the records 319-322 indicate that SMO bits were set to FALSE in the reverse order C3, C2, C1, P.

The B+ tree node splitting operation may then be committed, as illustrated by the record 323. Committing a database transaction may “finalize” the database transaction. That is, once a database transaction is committed, it may not be cancelled. In a particular embodiment, the exclusive SMO lock(s) acquired as indicated by the record 315 are automatically released when the B+ tree node splitting operation is committed. In another particular embodiment, release of acquired latches may also be delayed until the commit operation.

It should be noted that although the particular embodiment illustrated in FIG. 3 depicts the first value as “TRUE” (e.g., binary 1) and the second value as “FALSE” (e.g., binary 0), the values may be reversed. That is, the first value may instead be “FALSE” and the second value may instead be “TRUE.”

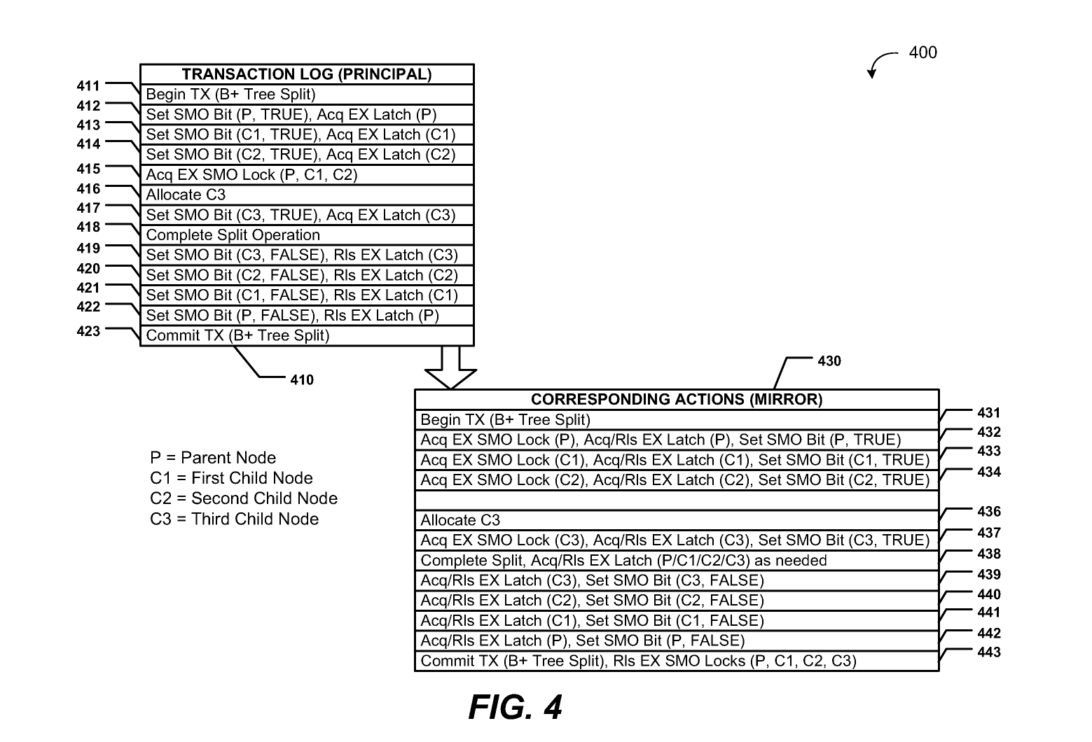

FIG. 4 is a diagram to illustrate operation 400 of a redo thread based on the transaction log of FIG. 3. For example, the redo thread may be the redo thread 132 of FIG. 1 at the mirror database 130 of FIG. 1. In an illustrative embodiment, the transaction log 410 is the transaction log 300 of FIG. 3, and the records 411-423 are the records 311-323 of FIG. 3.

A redo thread may traverse the transaction log 410 and perform corresponding actions 430 based on the transaction log 410. In a particular embodiment, a redo thread processes each record in a transaction in accordance with the following pseudocode:
1) If the record indicates that a database transaction was initiated at the principal database, initiate the same database transaction at the mirror database.
2) If the record indicates that the SMO bit of a page at the principal database was set to the first value (e.g., binary 1 or TRUE):
   a. Acquire an exclusive SMO lock for the corresponding page at the mirror database.
   b. Acquire an exclusive latch for the corresponding page.
   c. Set the SMO bit of the corresponding page to the first value.
   d. Release the exclusive latch for the corresponding page.
3) If the record indicates that data at a page at the principal database was modified (e.g., copied, deleted, or moved):
   a. Acquire an exclusive latch for the corresponding page at the mirror database.
   b. Modify the corresponding page (e.g., copy data, delete data, or move data) per the record.
   c. Release the exclusive latch for the corresponding page.
4) If the record indicates that the SMO bit of a page at the principal database was set to the second value (e.g., binary 0 or FALSE): acquire the exclusive latch for the corresponding page, set the SMO bit of the corresponding page at the second database to the second value, and release the exclusive latch for the corresponding page.
5) If the record indicates that a database transaction was committed at the principal database, commit the same database transaction at the mirror database (and release each exclusive SMO lock acquired in step 2a). If the record indicates that the database transaction was aborted, abort the same transaction at the mirror database (and release each exclusive SMO lock acquired in step 2a).

Thus, in accordance with the above pseudocode, a redo thread (e.g., the redo thread 132 at the mirror database 130 of FIG. 1) may traverse the transaction log 410 and perform the corresponding actions 430. The action 431 may be performed to initiate a B+ tree node splitting operation at the mirror database in response to the record 411 indicating that a B+ tree node splitting operation was initiated at the principal database.

The actions 432-434 may be performed in response to the records 412-414, respectively. During each of the actions 434, an exclusive SMO lock may be acquired for a particular page, an exclusive latch for the particular page may be acquired, the SMO bit of the particular page may be set to TRUE, and the exclusive latch for the particular page may be released.

The actions 436-437 may be performed in response to the records 416-417. During the action 436, a new page may be allocated at the mirror database. During the action 437, an exclusive SMO lock may be acquired for the new page, an exclusive latch for the new page may be acquired, the SMO bit of the new page may be set to TRUE, and the exclusive latch for the new page may be released.

In response to the record 418, the redo thread at the mirror database may complete the B+ tree node splitting operation at the mirror database, including copying, deleting and moving data, as indicated by the action 438. An exclusive latch may be acquired before any particular page is changed, and the exclusive latch may be released after the particular page has been changed.

In response to the records 419-422, the redo thread at the mirror database may acquire an exclusive latch, set the SMO bit to FALSE, and release the exclusive latch for C3, C2, C1, and P, respectively, as indicated by the actions 439-442. In response to the record 423 indicating that the B+ tree node splitting operation was committed at the principal database, the redo thread at the mirror database may commit the mirrored B+tree node splitting operation and release the acquired exclusive SMO locks, as illustrated by the action 443.

It will be appreciated that the system 100 of FIG. 1 (the operation of which is further illustrated in FIGS. 2-4) may enable the use of the mirror database 130 for read operations. It will further be appreciated that although all of the pages modified by a structure modification database transaction are concurrently latched at the principal database 110, the corresponding pages of the mirror database 130 are instead latched one-at-a-time. It should be noted that non-structure modification transactions at the primary database (e.g., data insertions) may latch pages one-at-a-time at the primary database. Thus, the reader threads 134 executing at the mirror database 130 may read from a particular page (e.g., a partial read operation) even though a structure modification database transaction associated with the particular page (and other pages) has not been fully completed or committed. Therefore, a total available read bandwidth of the principal database 110 and the mirror database 130 may be increased. It will also be appreciated that the order in which SMO bits are set to the first value and set to the second value is the same between the principal database 110 and the mirror database 130. Thus, deadlock situations caused by acquiring latches in different orders may be avoided.

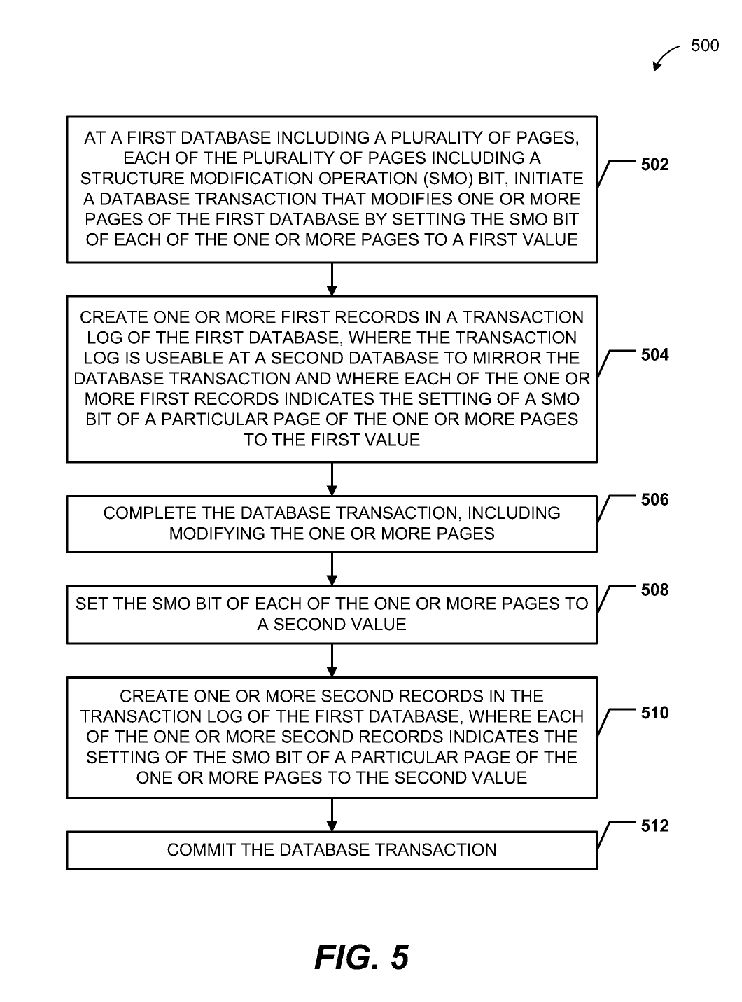

FIG. 5 is a flow diagram to illustrate a particular embodiment of a method 500 of operation at a principal database involved in database mirroring. In an illustrative embodiment, the method 500 may be performed at the principal database 110 of FIG. 1. For example, the method 500 may be performed by one of the writer threads 112 of FIG. 1.

The method 500 includes initiating a database transaction that modifies one or more pages of a first database, at 502. The first database includes a plurality of pages, and each page includes a SMO bit. Initiating the database transaction includes setting the SMO bit of each of the one or more pages to a first value. For example, in FIG. 1, a database transaction may be initiated at the principal database 110 and one or more of the SMO bits 141, 145, 149, and 153 may be set to TRUE.

The method 500 also includes creating one or more first records in a transaction log of the first database, at 504. The transaction log is useable at a second database to mirror the database transaction. Each of the first records indicates the setting of the SMO bit of a particular page of the one or more pages to the first value. For example, in FIG. 1, one or more first SMO records may be created at the transaction log 120. In an illustrative embodiment, the database transaction is a B+ tree split and the records are created as described with reference to the “Set SMO Bit (TRUE)” records 312-314 of the transaction log 300 of FIG. 3.

The method 500 further includes completing the database transaction, including modifying the one or more pages, at 506, and setting the SMO bit of each of the one or more pages to a second value, at 508. For example, in FIG. 1, one or more of the pages 140, 144, 148, and 152 may be modified and one or more of the SMO bits 141, 145, 149, and 153 may be set to FALSE.

The method 500 includes creating one or more second records in the transaction log, at 510. Each of the second records indicates the setting of the SMO bit of a particular page of the one or more pages to the second value. For example, one or more second SMO records may be created at the transaction log 120 of FIG. 1. In an illustrative embodiment, records indicating that the SMO bits are set to the second value are created as described with reference to the “Set SMO Bit (FALSE)” records 319-322 of the transaction log 300 of FIG. 3.

The method 500 also includes committing the database transaction, at 512. For example, in FIG. 1, the database transaction may be committed at the principal database 110.

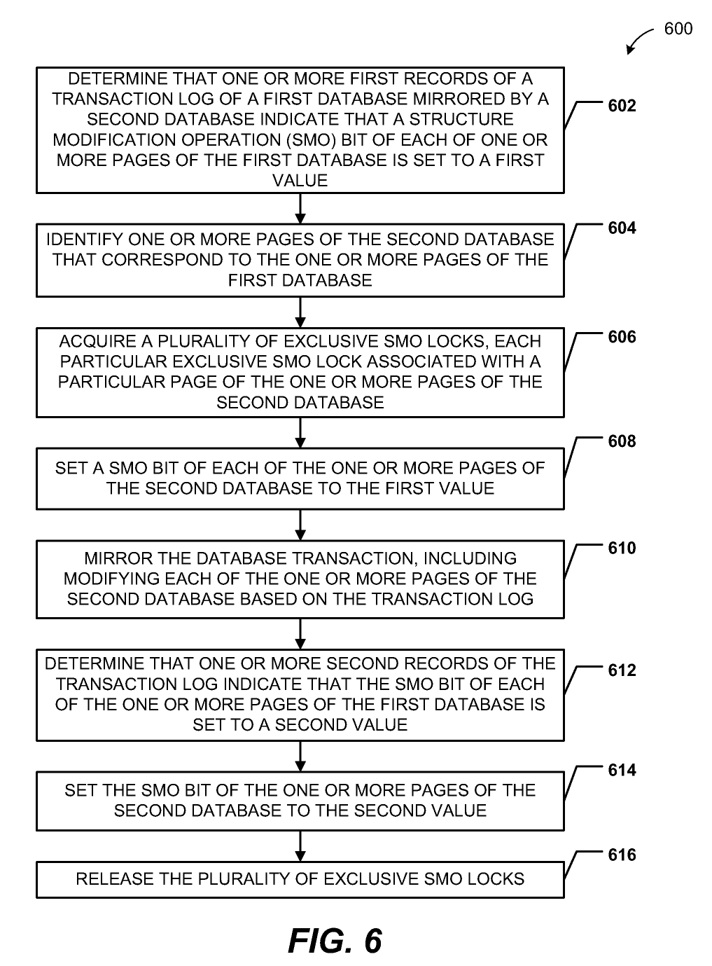

FIG. 6 is a flow diagram to illustrate a particular embodiment of a method 600 of redo thread operation at a mirror database involved in database mirroring. In an illustrative embodiment, the method 600 may be performed by the redo thread 132 of FIG. 1.

The method 600 includes determining that one or more first records of a transaction log of a first database indicate that a SMO bit of each of one or more pages of the first database is set to a first value, at 602. The first database is mirrored by a second database. For example, in FIG. 1, the redo thread 132 may determine that one or more first SMO records at the transaction log 120 indicate that one or more of the SMO bits 141, 145, 149, and 153 were set to TRUE. In an illustrative embodiment, the one or more first records are the “Set SMO Bit (TRUE)” records 412-414 of FIG. 4.

The method 600 also includes identifying one or more pages of the second database that correspond to the pages of the first database, at 604. For example, in FIG. 1, the redo thread 132 may identify one or more of the pages 160, 164, 168, and 172 that correspond to one or more of the pages 140, 144, 148, and 152.

The method 600 further includes acquiring a plurality of exclusive SMO locks, at 606. Each exclusive SMO lock is associated with a particular page of the one or more pages of the second database. For example, in FIG. 1, the redo thread 132 may acquire one or more exclusive SMO locks. In an illustrative embodiment, the exclusive SMO locks are acquired as described with reference to the “Acq SMO Lock” actions 432-434 of FIG. 4.

The method 600 includes setting a SMO bit of each of the one or more pages of the second database to the first value, at 608, and mirroring the database transaction, at 610. Mirroring the database transaction includes modifying the one more pages of the second database based on the transaction log. For example, in FIG. 1, the redo thread 132 may set one or more of the SMO bits 161, 165, 169, and 173 to TRUE and mirror the database transaction based on the transaction log 120. In an illustrative embodiment, the SMO bits at the mirror database are set as described with reference to the “Set SMO Bit (TRUE)” actions 432-434 of FIG. 4.

The method 600 further includes determining that one or more second records of the transaction log indicate that the SMO bit of each of the one or more pages of the first database is set to a second value, at 612. For example, in FIG. 1, the redo thread 132 may determine that one or more second SMO records at the transaction log 120 indicate that one or more of the SMO bits 141, 145, 149, and 153 were set to FALSE. In an illustrative embodiment, the one or more second records are the “Set SMO Bit (FALSE)” records 419-422 of FIG. 4.

The method 600 includes setting the SMO bit of the one or more pages of the second database to the second value. For example, in FIG. 1, the redo thread 132 may set one or more of the SMO bits 161, 165, 169, and 173 to FALSE. In an illustrative embodiment, the SMO bits are set as described with reference to the “Set SMO Bit (FALSE)” actions 439-442 of FIG. 4.

The method 600 also includes releasing the plurality of exclusive SMO locks, at 616. For example, in FIG. 1, the redo thread 132 may release the plurality of exclusive SMO locks. In an illustrative embodiment, the exclusive SMO locks are released as described with reference to the “Rls EX SMO Locks” action 443 of FIG. 4.

Because database mirroring as disclosed herein may enable concurrent operation of a redo thread and reader threads at a mirror database, a synchronization method may be used at the reader threads to avoid data integrity issues and deadlock scenarios. For example, a particular read operation may involve reading data from mirror database pages that correspond to the child nodes (i.e., leaf nodes) C1, C3 210, 240 of FIG. 2. Performing such a read operation may involve reading data from C1 210, crabbing left-to-right from C1 210 to C3 240 (e.g., “crabbing” typically involves moving a thread from a first node (e.g., C1 210) to a second node (e.g., C3 240) by holding a latch of the first node (e.g., C1 210), traversing a pointer (e.g., a “next leaf node” pointer) of the first node (e.g., C1 210), acquiring a latch of the second node (e.g., C3 240), and releasing the latch of the first node (e.g., C1 210)), and reading data from C3 240. Because pages at a mirror database are individually latched, when a reader thread attempts to crab from C1 210 to C3 240, the reader thread may notice that the SMO bit for C3 240 has become set to TRUE. In such a situation, synchronization may be performed in accordance with the following pseudocode (where steps 1 and 2 were performed prior to the attempted crab from C1 210 to C3 240):
1) Initiate a read operation of the first page and the second at the mirror database.
2) Acquire a shared latch for the first page and read data from the first page.
3) Acquire a shared latch for the second page.
4) If the SMO bit of the second page is TRUE, proceed to step 5. If the SMO bit of the second page is FALSE, skip steps 5-8 and complete the read operation by reading data from the second page.
5) Store a log sequence number (LSN) of the first page.
6) Release both the first shared latch and the second shared latch.
7) Acquire a shared SMO lock for the second page. If the shared SMO lock is not immediately granted, wait (e.g., sleep) until the shared SMO lock is granted.
8) Once the shared SMO lock for the second page is acquired, verify that the LSN of the first page did not change while the reader thread was asleep.
   a. If the LSN has changed, the previously read data from the first page is out of date (e.g., a data modification occurred at the first page). Therefore, reposition the reader thread and restart at step 1).
   b. If the LSN has not changed, then reacquire the shared latch for the second page, verify that the SMO bit of the second page is no longer set to the second value, and complete the read operation by reading data from the second page.

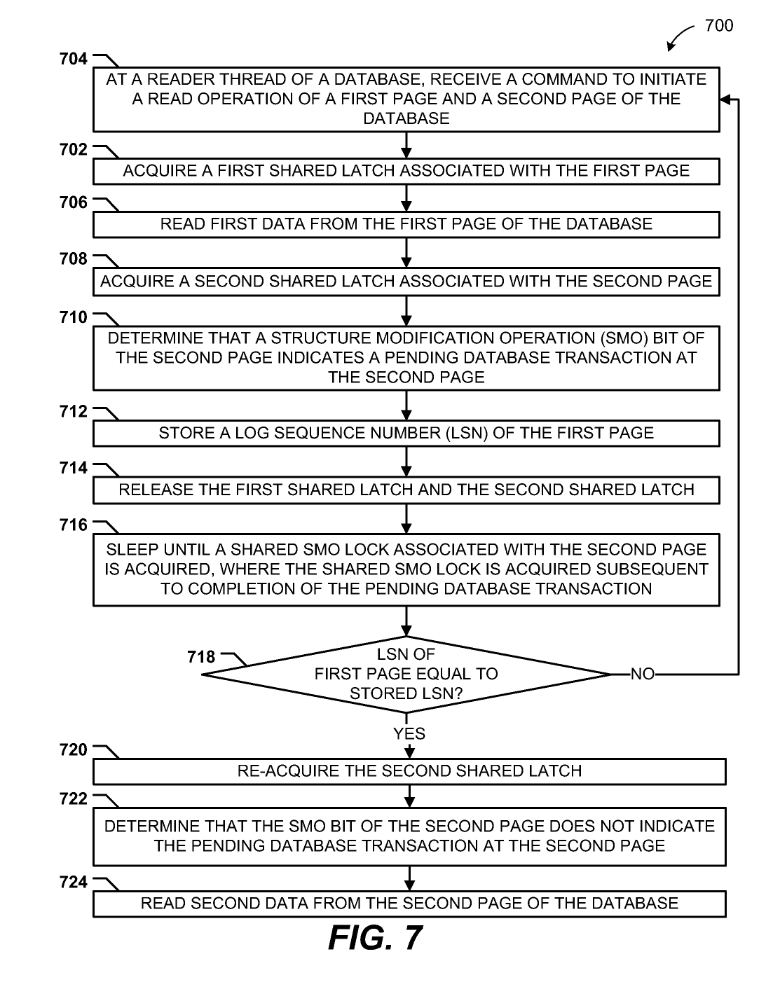

FIG. 7 is a flow diagram to illustrate a particular embodiment of a method 700 of reader thread operation at a mirror database involved in database mirroring as described herein. In an illustrative embodiment, the method 700 may be performed by the reader threads 134 of FIG. 1.

The method 700 includes receiving a command to initiate a read operation of a first page and a second page of a database at a reader thread of the database, at 702. For example, in FIG. 1, a reader thread of the reader threads 134 may initiate a read operation of the pages 164 and 168.

The method 700 also includes acquiring a first shared latch associated with the first page, at 704. For example, in FIG. 1, the reader thread may acquire a shared latch associated with the first page 164. The method 700 further includes reading data from the first page of the database, at 706. For example, in FIG. 1, the reader thread may read the data 167 from the first page 164.

The method 700 includes acquiring a second shared latch associated with the second page, at 708. For example, in FIG. 1, the reader thread may acquire a second shared latch associated with the second page 168 when attempting to crab (e.g., traverse) from the first page 164 to the second page 168.

The method 700 also includes determining that a SMO bit of the second page indicates a pending database transaction at the second page, at 710. For example, in FIG. 1, the reader thread may determine that the SMO bit 169 of the second page 168 is TRUE, indicating that the redo thread 132 is modifying the second page 168.

The method 700 further includes storing a LSN of the first page, at 712, and releasing the first shared latch and the second shared latch, at 714. For example, in FIG. 1, the reader thread may store the LSN 166 of the first page 164 and then release the first shared latch and the second shared latch.

The method 700 also includes sleeping until a shared SMO lock associated with the second page is acquired, at 716. The shared SMO lock is acquired subsequent to completion of the pending database transaction. For example, in FIG. 1, the reader thread may sleep until a shared SMO lock for the second page 168 is acquired. The shared SMO lock may be acquired after the redo thread 132 has finished modifying the second page 168.

The method 700 includes determining whether the LSN of the first page is equal to the stored LSN, at 718. When the LSN is not equal to the stored LSN (i.e., the first page was modified while the reader thread was asleep), the method 700 returns to 702. For example, the LSNs may not match due to a deallocation of the first page, a deletion of a file that includes the first page, or a shrink operation of the file that includes the first page.

When the LSN is equal to the stored LSN (i.e., the first page did not change while the reader thread was asleep), the method 700 includes re-acquiring the second latch, at 720, and determining that the SMO bit of the second page does not indicate a pending transaction at the second page, at 722. For example, in FIG. 1, the redo thread 132 may re-acquire the second latch and verify that the SMO bit 169 of the second page 168 is FALSE. The method 700 further includes reading second data from the second page, at 724. For example, in FIG. 1, the redo thread 132 may complete the read operation by reading the data 171 from the second page 168.

It will be appreciated that the method 700 of FIG. 7 may be used at reader threads of mirror databases to avoid data integrity issues and deadlock scenarios. It will also be appreciated that the method 700 of FIG. 7 may provide intelligent repositioning of reader threads in the case of intervening deallocation operations, deletion operations, and shrink operations.

In a particular embodiment, database transactions may occur at one of five possible isolation levels: a read uncommitted isolation level (e.g., shared locks are not issued—therefore it is possible to read uncommitted data), a read committed isolation level (e.g., shared locks are issued, so only committed data is read), a repeatable read isolation level (e.g., all shared locks are held until the end of a transaction), a snapshot isolation level (e.g., data read at any point during a read operation will be consistent with the data that existed at the start of the read operation), or a serializable isolation level (e.g., data that has modified cannot be read or re-modified until committed). It will be appreciated that database mirroring as disclosed herein may enable mirroring of transactions at a snapshot isolation level. Because SMO bits are set to TRUE in the same order at the principal database and the mirror database, because SMO bits set to FALSE in the same (reverse) order at the principal database and the mirror database, and because only one latch is held at any time at the mirror database, data read during any point of the transaction will be consistent with the data at the beginning of the transaction.

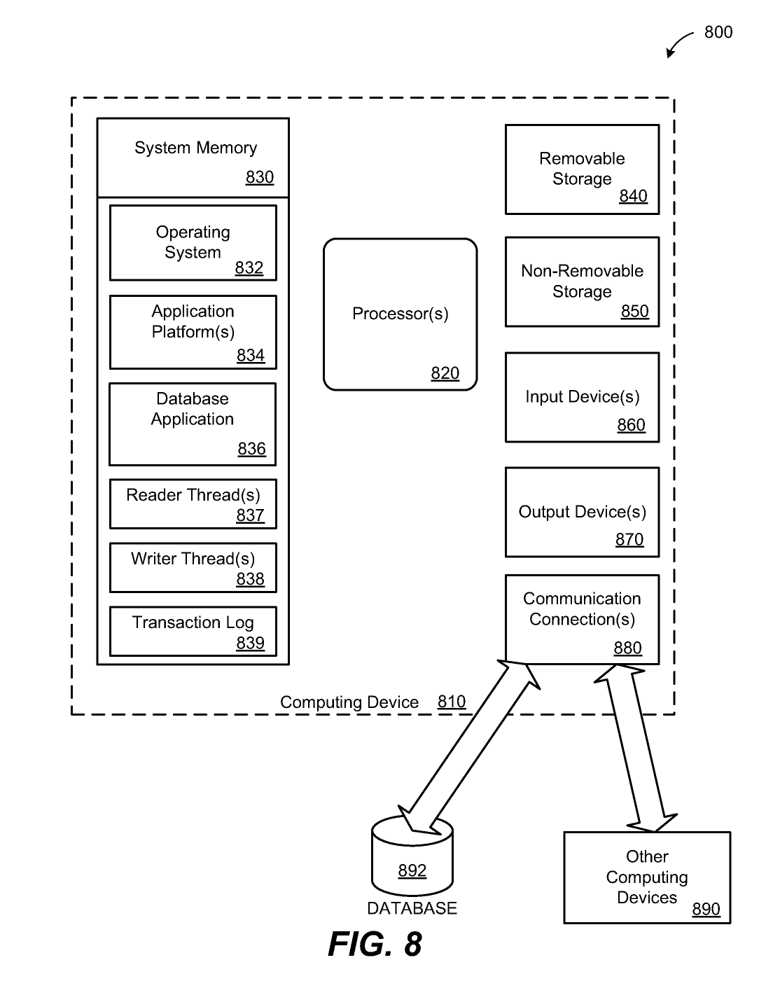

FIG. 8 depicts a block diagram of a computing environment 800 including a computing device 810 operable to support embodiments of computer-implemented methods, computer program products, and system components according to the present disclosure. In an illustrative embodiment, the computing device 810 may include one or more of the principal database 110 of FIG. 1, the writer threads 112 of FIG. 1, the reader threads 114 of FIG. 1, the transaction log 120 of FIG. 1, the mirror database 130 of FIG. 1, the redo thread 132 of FIG. 1, the reader threads 134 of FIG. 1, the nodes 210-240 of FIG. 2, the transaction log 300 of FIG. 3, or the transaction log 410 of FIG. 4. Each of the principal database 110 of FIG. 1, the writer threads 112 of FIG. 1, the reader threads 114 of FIG. 1, the transaction log 120 of FIG. 1, the mirror database 130 of FIG. 1, the redo thread 132 of FIG. 1, the reader threads 134 of FIG. 1, the nodes 210-240 of FIG. 2, the transaction log 300 of FIG. 3, or the transaction log 410 of FIG. 4 may include or be implemented using the computing device 810 or a portion thereof.

The computing device 810 includes at least one processor 820 and a system memory 830. Depending on the configuration and type of computing device, the system memory 830 may be volatile (such as random access memory or “RAM”), non-volatile (such as read-only memory or “ROM,” flash memory, and similar memory devices that maintain stored data even when power is not provided), or some combination of the two. The system memory 830 typically includes an operating system 832, one or more application platforms, one or more applications (e.g., a database application 836 including reader thread(s) 837 and writer thread(s) 838), and program data (e.g., a transaction log 839) associated with the one or more applications. In an illustrative embodiment where the database application 836 provides access to the principal database 110 of FIG. 1, the reader thread(s) 837 are the reader threads 114 of FIG. 1 and the writer thread(s) 838 are the writer threads 112 of FIG. 1. In another illustrative embodiment where the database application 836 provides access to the mirror database 130 of FIG. 1, the reader thread(s) 837 are the reader threads 134 of FIG. 1 and the writer thread(s) 838 are the redo thread 132 of FIG. 1. In an illustrative embodiment, the transaction log 839 is the transaction log 120 of FIG. 1, the transaction log 300 of FIG. 3, or the transaction log 410 of FIG. 4.

The computing device 810 may also have additional features or functionality. For example, the computing device 810 may also include removable and/or non-removable additional data storage devices such as magnetic disks, optical disks, tape, and flash memory cards. Such additional storage is illustrated in FIG. 8 by removable storage 840 and non-removable storage 850. In an illustrative embodiment, one or both of the principal database 110 of FIG. 1 and the mirror database 130 of FIG. 1 may be stored at one or both of the removable storage 740 or the non-removable storage 750. Computer storage media may include volatile and/or non-volatile storage and removable and/or non-removable media implemented in any technology for storage of information such as computer-readable instructions, data structures, program components or other data. The system memory 830, the removable storage 840 and the non-removable storage 850 are all examples of computer storage media. The computer storage media includes, but is not limited to, RAM, ROM, electrically erasable programmable read-only memory (EEPROM), flash memory or other memory technology, compact disks (CD), digital versatile disks (DVD) or other optical storage, magnetic cassettes, magnetic tape, magnetic disk storage or other magnetic storage devices, or any other medium that can be used to store information and that can be accessed by the computing device 810. Any such computer storage media may be part of the computing device 810.

The computing device 810 may also have input device(s) 860, such as a keyboard, mouse, pen, voice input device, touch input device, etc. Output device(s) 870, such as a display, speakers, printer, etc. may also be included. The computing device 810 also contains one or more communication connections 880 that allow the computing device 810 to communicate with other computing devices 890 and a database 892 over a wired or a wireless network. For example, the database 892 may be the principal database 110 of FIG. 1 or the mirror database 130 of FIG. 1.

It will be appreciated that not all of the components or devices illustrated in FIG. 8 or otherwise described in the previous paragraphs are necessary to support embodiments as herein described. For example, the input device(s) 860 and output device(s) 870 may be optional.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Accordingly, the disclosure and the figures are to be regarded as illustrative rather than restrictive.

Those of skill would further appreciate that the various illustrative logical blocks, configurations, modules, and process steps or instructions described in connection with the embodiments disclosed herein may be implemented as electronic hardware or computer software. Various illustrative components, blocks, configurations, modules, or steps have been described generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The steps of a method described in connection with the embodiments disclosed herein may be embodied directly in hardware or in a software module executed by a processor. A software module may reside in computer readable media, such as random access memory (RAM), flash memory, read only memory (ROM), registers, a hard disk, a removable disk, a CD-ROM, or any other form of storage medium known in the art. An exemplary storage medium is coupled to a processor such that the processor can read information from, and write information to, the storage medium. In the alternative, the storage medium may be integral to the processor or the processor and the storage medium may reside as discrete components in a computing device or computer system.

Although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments.

The Abstract of the Disclosure is provided with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments.

The previous description of the embodiments is provided to enable a person skilled in the art to make or use the embodiments. Various modifications to these embodiments will be readily apparent to those skilled in the art, and the generic principles defined herein may be applied to other embodiments without departing from the scope of the disclosure. Thus, the present disclosure is not intended to be limited to the embodiments shown herein but is to be accorded the widest scope possible consistent with the principles and novel features as defined by the following claims.

What is claimed is:

1. A method, comprising:
at a first database comprising a plurality of pages, each of the plurality of pages including a structure modification operation (SMO) bit, initiating a database transaction that modifies one or more pages of the first database by setting the SMO bit of each of the one or more pages to a first value;
creating one or more first records in a transaction log of the first database, wherein the transaction log is useable at a second database to mirror the database transaction and wherein each of the one or more first records indicates the setting of a SMO bit of a particular page of the one or more pages to the first value;
performing the database transaction, comprising modifying the one or more pages;
setting the SMO bit of each of the one or more pages to a second value;
creating one or more second records in the transaction log of the first database, wherein each of the one or more second records indicates the setting of the SMO bit of a particular page of the one or more pages to the second value; and
committing the database transaction.

2. The method of claim 1, further comprising:
acquiring one or more exclusive SMO locks associated with the one or more pages prior to performing the database transaction;
creating one or more lock records associated with the exclusive SMO locks in the transaction log; and
releasing the one or more exclusive SMO locks after performing the database transaction.

3. The method of claim 1, further comprising:
acquiring an exclusive latch associated with each of the one or more pages prior to performing the database transaction; and
releasing the exclusive latch associated with each of the one or more pages after performing the database transaction.

4. The method of claim 1, wherein the plurality of pages is stored in a binary-plus-tree structure (B+ tree).

5. The method of claim 4, wherein the database transaction is a structure modification operation (SMO) of the B+ tree.

6. The method of claim 4, wherein SMO bits of each of the one or more pages are set to the first value prior to performing the database transaction in a particular order of the B+ tree.

7. The method of claim 6, wherein the particular order is a top-down left-to-right order.

8. The method of claim 6, wherein SMO bits of each of the one or more pages are set to the second value after performing the database transaction in a reverse of the particular order.

9. The method of claim 1, wherein the SMO bit of the particular page is included in a header of the particular page.

10. The method of claim 1, wherein the first value is a binary one and the second value is a binary zero.

11. The method of claim 1, wherein the first value is a binary zero and the second value is a binary one.

12. The method of claim 1, wherein the transaction log comprises a plurality of records, wherein each of the plurality of records has an associated log sequence number (LSN).

13. A method of mirroring a database transaction of a first database at a second database based on a transaction log of the first database, the method comprising:
determining that one or more first records of the transaction log indicate that a structure modification operation (SMO) bit of each of one or more pages of the first database is set to a first value;
identifying one or more pages of the second database that correspond to the one or more pages of the first database;
acquiring one or more exclusive SMO locks, each particular exclusive SMO lock associated with a particular page of the one or more pages of the second database;
setting a SMO bit of each of the one or more pages of the second database to the first value;
mirroring the database transaction comprising modifying each of the one or more pages of the second database based on the transaction log;
determining that one or more second records of the transaction log indicate that the SMO bit of each of the one or more pages of the first database is set to a second value;
setting the SMO bit of the one or more pages of the second database to the second value; and
releasing the plurality of exclusive SMO locks.

14. The method of claim 13, further comprising:
prior to modifying a page of the second database, acquiring an exclusive latch associated with the page of the second database; and
after modifying the page of the second database, releasing the exclusive latch associated with the page of the second database;
wherein the exclusive latch associated with the page of the second database is not granted until any previously acquired exclusive latch is released.

15. The method of claim 13, wherein the first value indicates a pending database transaction and wherein the second value indicates no pending database transaction.

16. The method of claim 13, wherein the database transaction of the first database is mirrored at a snapshot isolation level of the second database.

17. A computer-readable medium comprising instructions, that when executed by a computer, cause the computer to:
at a reader thread of a database, receive a command to initiate a read operation of a first page and a second page of the database;
acquire a first shared latch associated with the first page;
read first data from the first page of the database;
acquire a second shared latch associated with the second page;
determine that a structure modification operation (SMO) bit of the second page indicates a pending database transaction at the second page;
release the first shared latch and the second shared latch;
sleep until a shared SMO lock associated with the second page is acquired, wherein the shared SMO lock is acquired subsequent to completion of the pending database transaction;
after acquiring the shared SMO lock, re-acquire the second shared latch;
determine that the SMO bit of the second page does not indicate the pending database transaction at the second page; and
read second data from the second page of the database.

18. The computer-readable medium of claim 17, wherein when the first data is read from the first page of the database, a SMO bit of the first page does not indicate a pending transaction at the first page.

19. The computer-readable medium of claim 17, further comprising instructions, that when executed by the computer, cause the computer to:
prior to sleeping, store a first value of a log sequence number (LSN) of the first page;
after acquisition of the shared SMO lock, re-acquire the first shared latch;
determine that a second value of the log sequence number (LSN) of the first page does not match the stored first value of the LSN; and
in response to the determination, restart the read operation of the first page and the second page.

20. The computer-readable medium of claim 19, wherein the second value of the LSN of the first page does not match the stored first value of the LSN due to a data modification at the first page.
